(19) United States
(12) Patent Application Publication
(10) Pub. No.: US 2007/0074571 A1
(43) Pub. Date: Apr. 5, 2007

(54) Ultrasonic sensor self test

(76) Inventors: Kevin M. Haynes, Lombard, IL (US); Paul G. Janitch, Lisle, IL (US); James A. Bosserman, Aurora, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/242,248

(22) Filed: Oct. 3, 2005

(51) Int. Cl. G01N 29/04

(52) U.S. Cl. 73/584

(57) ABSTRACT

An ultrasonic measurement instrument comprises a housing including a pair of spaced apart legs to define a gap therebetween. Each leg includes an interior cavity. An ultrasonic circuit comprises a transmit circuit for driving a transmit crystal receive in the interior cavity of one of the legs and a receive circuit for receiving signals from a receive crystal in the interior cavity of the other of the legs. A measurement circuit is connected to the ultrasonic circuit to periodically generate pulses in the transmit crystal and to sense pulses from the receive crystal to detect presence of a material in the gap. A self test circuit is operatively associated with the measurement circuit and electrically connected to the ultrasonic circuit for periodically testing operation of the ultrasonic circuit.

### CROSS REFERENCE TO RELATED APPLICATIONS

There are no related applications.

### FIELD OF THE INVENTION

This invention relates to an ultrasonic measurement instrument and, more particularly, to an ultrasonic sensor self test.

### BACKGROUND OF THE INVENTION

Knowledge of process variables, such as level, in industrial process tanks or vessels has long been required for safe and cost-effective operation of plants. Many technologies exist for making level measurements. These include buoyancy, capacitance, ultrasonic and microwave radar, to name a few. Level measurement instruments may provide a continuous signal indicating level of the material in a tank or vessel, or may comprise point level measurement instruments that indicate the presence or absence of the material at a discrete level in the tank or vessel.

Ultrasonic level measurement instruments are designed for non-contact sensing or contact sensing. Contact liquid level sensing for point measurement is achieved by using continuous-wave or pulse-signal technology. Continuous-wave instruments have two piezoelectric crystals mounted opposite each other in a transducer body, separated by a gap. The transmit crystal produces an acoustical signal when subjected to an implied voltage from an amplifier circuit. The receive crystal converts the acoustical signal that it receives into an electrical signal, which becomes the input of the same amplifier circuit. When liquid is present in the transducer gap, the amplifier becomes an oscillator causing a relay circuit in the electronics to indicate a wet gap condition. When liquid vacates the gap, the amplifier returns to an idle state.

In pulse-signal units, a digital electronic amplifier produces a powerful pulse of ultrasonic energy more powerful than with most continuous-wave instruments. This allows measurement in conditions that include aeration, suspended solids, turbulence, and highly viscous liquids. Pulses of high-frequency ultrasonic energy tens of microseconds in duration are produced by the transmit crystal. In between each pulse, the receive crystal “listens” for the transmission. If liquid is present in the gap, the receive crystal detects the pulse and reports a wet gap condition to the electronics. When the gap is filled with air, the receive crystal cannot detect a pulse and reports a dry gap condition.

A transducer in one known form includes a housing with a pair of spaced apart legs to define a gap therebetween. Piezoelectric crystal assemblies that form the sensor drive and receive elements are received in each leg.

Advantageously, a process measurement instrument should be periodically tested to verify proper operation of the instrumentation circuitry. Performance of such tests often require the instrument be removed from its application. This usually entails disconnecting electrical terminations and conduits and other appurtenances. Not only is such a procedure time consuming, it might also require process down time.

One known type of self test used with ultrasonic measurement instruments does not require removal of the instrument. Instead, some of the ultrasonic energy is transmitted through the sensor housing. During self test operation, measurement circuitry is adjusted to sense this energy. Such a test confirms integrity of the sensor assembly. However, such a test should be done under dry conditions to produce reliable results. False positive results can result under wet conditions.

The known self test requires elevated levels of acoustic noise in the sensor. If the noise level is too high (caused by temperature change, for example), a false wet result can occur.

The present invention is directed to solving one or more of the problems discussed above in a novel and simple manner.

### SUMMARY OF THE INVENTION

In accordance with the invention, there is provided an ultrasonic sensor self test for periodic testing of operation of ultrasonic circuitry.

Broadly, in accordance with one aspect of the invention, there is disclosed an ultrasonic measurement instrument comprising a housing including a pair of spaced apart legs to define a gap therebetween. Each leg includes an interior cavity. An ultrasonic circuit comprises a transmit circuit for driving a transmit crystal received in the interior cavity of one of the legs and a receive circuit for receiving signals from a receive crystal in the interior cavity of the other of the legs. A measurement circuit is connected to the ultrasonic circuit to periodically generate pulses in the transmit crystal and to sense pulses from the receive crystal to detect presence of a material in the gap. A self test circuit is operatively associated with the measurement circuit and electrically connected to the ultrasonic circuit for periodically testing operation of the ultrasonic circuit.

It is a feature of the invention that the self test circuit comprises a sense resistor connected across each crystal and a resistor network selectively connected to each sense resistor and the measurement circuit detects each resistor network to confirm that each crystal is properly connected.

It is another feature of the invention that the measurement circuit selectively varies resistance of each resistor network to test for open and shorted circuit conditions.

It is a further feature of the invention that the self test circuit comprises a circuitry test circuit electrically connected between the transmit circuit and the receive circuit so that a portion of drive energy is coupled from the transmit circuit to the receive circuit and the measurement circuit verifies that a number of receive electrical pulses generally matches a number of driven pulses to confirm operation of the ultrasonic circuit.

It is an additional feature of the invention that the self test circuit comprises a capacitor and a resistor connected in series between the transmit circuit and the receive circuit.

It is still a further feature of the invention that the measurement circuit implements a noise test to detect sense pulses from the receive crystal in the absence of any generated pulses in the transmit crystal.

There is disclosed in accordance with another aspect of the invention an ultrasonic measurement instrument comprising a housing including a pair of spaced apart legs to define a gap therebetween, each leg including an interior cavity. An ultrasonic circuit comprises a pair of crystal assemblies each comprising a crystal having a sense resistor connected across the crystal. Each of the crystal assemblies is received in the interior cavity of one of the legs. A measurement circuit is connected to the ultrasonic circuit to periodically generate pulses in one of the crystals and to sense pulses from the other crystal to detect presence of a material in the gap. A self test circuit is operatively associated with the measurement circuit and comprises a resistor network selectively connected to each sense resistor and the measurement circuit detects each resistor network to confirm that each crystal is properly connected.

There is disclosed in accordance with a further aspect of the invention an ultrasonic measurement instrument comprising a housing including a pair of spaced apart legs to define a gap therebetween, each leg including an interior cavity. An ultrasonic circuit comprises a transmit circuit for driving a transmit crystal received in the interior cavity of one of the legs and a receive circuit for receiving signals from a receive crystal in the interior cavity of the other of the legs. A measurement circuit is connected to the ultrasonic circuit to periodically generate pulses in the transmit circuit and to sense pulses from the receive crystal to detect presence of a material in the gap. A self test circuit is operatively associated with the measurement circuit comprising a circuitry test circuit electrically connected between the transmit circuit and the receive circuit so that a portion of drive energy is coupled from the transmit circuit to the receive circuit and the measurement circuit verifies that a number of received electrical pulses generally matches a number of driven pulses to confirm operation of the ultrasonic circuit.

Further features and advantages of the invention will be readily apparent from the specification and from the drawings.

### BRIEF DESCRIPTION OF THE DRAWINGS

FIG. 1 is a side elevation view of an ultrasonic measurement instrument including an ultrasonic sensor self test in accordance with the invention;

FIG. 2 is a sectional view of an ultrasonic sensor assembly removed from the instrument of FIG. 1;

FIG. 3 is a combined schematic and block diagram of electrical circuitry of the instrument of FIG. 1;

FIG. 4 is an electrical schematic of wiring test circuitry and crystal assemblies of the circuit of FIG. 3;

FIGS. 5A-5C comprise a flow diagram illustrating operation of software implemented in the controller circuit of FIG. 3;

FIG. 6 is a timing diagram illustrating operation of a self test circuit for confirming operation of the ultrasonic circuit; and

FIGS. 7, 8 and 9 comprise timing diagrams illustrating operation of a self test for testing for open and shorted circuit conditions.

### DETAILED DESCRIPTION OF THE INVENTION

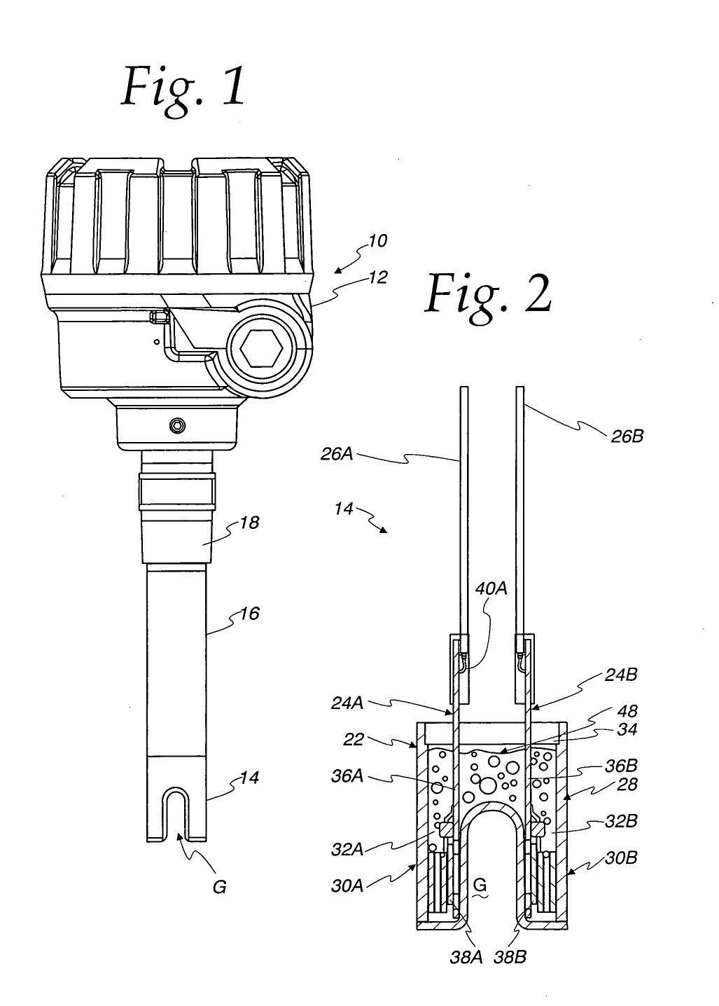

Referring to FIG. 1, a process measurement instrument 10 according to the invention is illustrated. The process measurement instrument 10 uses ultrasound technology for measuring point level. Particularly, an acoustic signal is transmitted between crystals to detect presence or absence of a material in a gap.

The process measurement instrument 10 includes a control housing 12, a transducer 14 and an extension tube 16 connecting the transducer 14 to the control housing 12. The extension tube 16 may include a threaded fitting 18 for connection to a process vessel. Alternatively, a flange or other structure may be used.

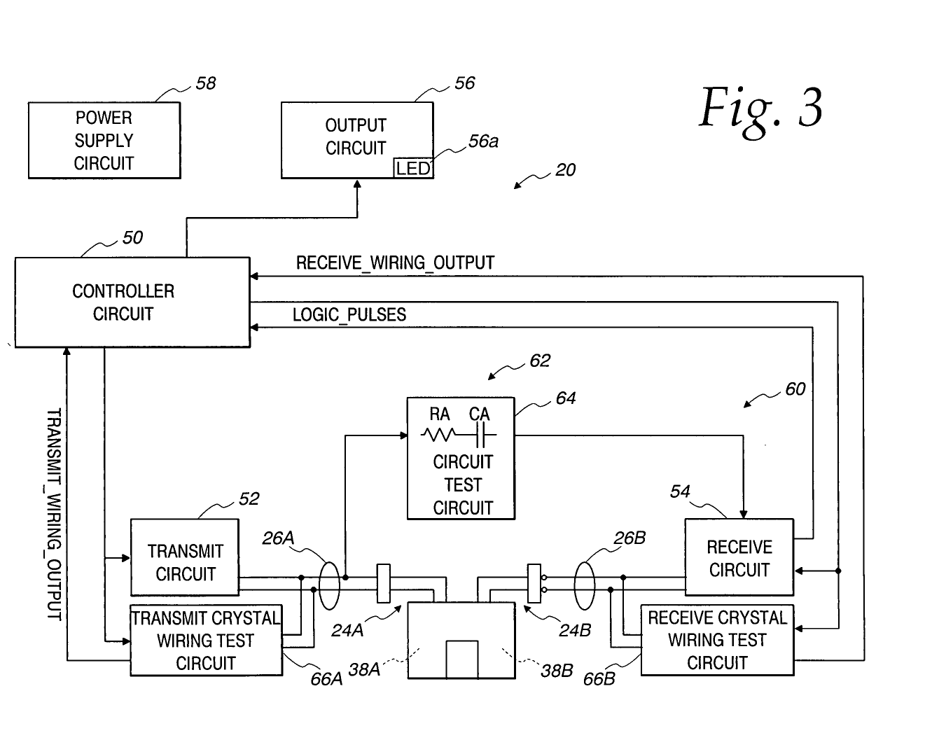

The control housing 12 houses a measurement circuit 20, see FIG. 3. The measurement circuit 20 is electrically connected, as described more particularly below, to a sensor assembly in the form of the transducer 14.

Referring particularly to FIG. 2, the transducer, i.e., sensor assembly, 14 includes a metal housing 22, a pair of crystal assemblies 24A and 24B, and a pair of cables 26A and 26B electrically connecting the respective crystal assemblies 24A and 24B to the measurement circuit 20, see FIG. 3.

The housing 22 includes a generally cylindrical body 28 with a pair of spaced apart legs 30A and 30B extending from the body 28. The legs 30A and 30B are generally semi-cylindrical. Each leg includes an interior cavity 32A and 32B opening to an interior space 34 of the body 28. As is apparent, the radius of the semi-cylindrical legs 30A and 30B correspond to that of the body 28 to provide a continuous, seamless construction, as is particularly apparent in FIG. 1. The legs 30A and 30B face one another to define a gap G therebetween.

The transducer housing 22 can be formed of various materials such as, for example, stainless steel. The particular material used for the housing 22 does not itself form part of the invention. Moreover, while the housing 22 is illustrated as being cylindrical with generally semi-cylindrical legs, other constructions can be used to form a gap.

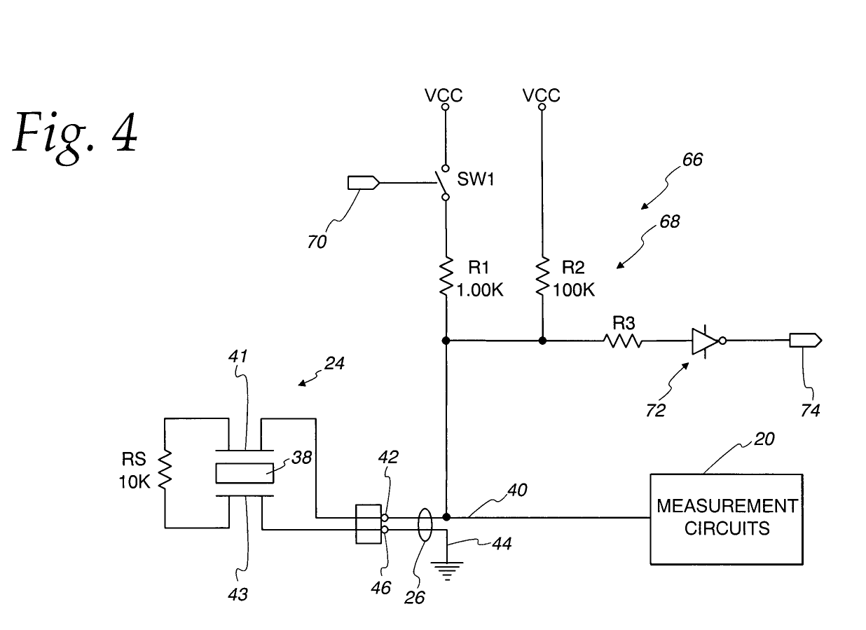

Referring to FIG. 4, a crystal assembly 24 is schematically illustrated. In accordance with the invention, the crystal assemblies 24A and 24B, discussed above, are identical in construction. For simplicity, they may be described generically herein omitting the suffix A or B. A crystal 38 is generally planar and include opposite first and second conductive surfaces 41 and 43, respectively. In the illustrated embodiment of the invention, the crystal 38 is approximately 0.38″ square and 0.040″ thick.

Each crystal assembly 24A and B includes a printed circuit board 36A and B, respectively, see FIG. 2.

In the illustrated embodiment of the invention, each cable 26 is a coaxial cable. A center conductor 40 is connected to a first terminal 42 of the crystal assembly 24. An outer braid 44 is connected to a second terminal 46. On the printed circuit board 36, the first terminal 42 is electrically connected to the first conductive surface 41. A sense resistor RS is connected between the conductive surfaces 41 and 43. The second conductive surface 43 is connected to the second terminal 46. As such, the sense resistor RS is connected across the crystal 38 and is used as part of a self test circuit, as described below.

Referring to FIG. 3, the measurement circuit 20 comprises a controller circuit 50, a transmit circuit 52, a receive circuit 54 and an output circuit 56. The measurement circuit 20 is powered by a suitable power supply circuit 58, as is conventional.

As shown. in FIG. 2, the first crystal assembly 24A is received in the first leg 32A and the second crystal assembly 24B is received in the second leg 32B. A potting compound 48 fills the interior space 34 and the cavities 32A and 32B.

As described above, the crystal assemblies 24A and 24B are identical in construction. One is used as a transmit crystal and the other is used as a receive crystal. The particular function is dependent on how the sensor assembly 14 is mounted and wired to the measurement circuit 20. In the illustrated embodiment of the invention, the first crystal assembly 24A is described as a transmit crystal assembly and the second crystal assembly 24B is described as a receive crystal assembly.

The controller circuit 50 comprises a micro controller or microprocessor or the like with associated memory operating in accordance with a control program for controlling operation of the transmit circuit 52, receive circuit 54 and output circuit 56, including a fault LED 56a. The controller circuit 50 is conventional in construction and is not described in detail herein. The transmit circuit 52 includes conventional oscillator and drive circuits for driving the transmit crystal 38A received in the interior cavity 32A of the first leg 30A. The receive circuit 54 includes amplifiers and comparators for receiving signals from the receive crystal 38B in the interior cavity 32B of the second leg 30B. The transmit circuit 52 and receive circuit 54 define an ultrasonic circuit 60. The transmit circuit 52 operates under control of the controller circuit 50 to periodically generate pulses in the transmit crystal 38A. The receive circuit 54 senses pulses from the receive crystal 38B indicated as LOGIC PULSES. The control circuit 50 analyzes the LOGIC PULSES in a conventional manner to determine the presence or absence of a material in the gap G.

In accordance with the invention, a self test circuit 62 is operatively associated with the measurement circuit 20 for periodically testing operation of the ultrasonic circuit 60. The self test circuit 62 comprises the sense resistors RS, discussed above relative to FIG. 4, a circuitry test circuit 64, a transmit crystal wiring test circuit 66A and a receive crystal wiring test circuit 66B. The wiring test circuits 66A and 66B are identical in construction and are generically illustrated as reference numeral 66 in FIG. 4, described below.

The circuitry test circuit 64 comprises a series connected resistor RA and capacitor CA connected between the transmit circuit 52 and the receive circuit 54. Particularly, the circuitry test circuit 64 is adapted so that a portion of electrical drive energy is coupled from the transmit circuit 52 to the receive circuit 54. As is conventional, the transmit circuit 52 develops an electrical pulse signal on the cable 26A to drive the transmit crystal 38A to generate an acoustic pulse signal. Any acoustic pulses sensed by the receive crystal 38B are amplified and output to the controller circuit 50. The circuitry test circuit 64 bleeds some of the electrical pulse energy into the receive circuit 54 where it is combined with the signals representing the receive acoustic pulses and transmitted to the controller circuit 50, as described more particularly below.

Referring to FIG. 4, the wiring test circuit 66 used in the transmit crystal wiring test circuit 66A and the receive crystal wiring circuit 66B is illustrated schematically. The self test circuit 66 includes a resistor network 68 comprising resistors R1, R2, R3 and the sense resistor RS. Particularly, the first resistor R1 is connected in series with a switch SW1 between supply voltage VCC and the first terminal 42. The switch SW1 is operated by a node 70 from the controller circuit 50. The second resistor R2 is connected between the supply VCC and the first terminal 42. The third resistor R3 is connected between the first terminal 42 and an inverter 72. The inverter is connected to an output 74 to the controller circuit shown as “transmit wiring output” or “receive wiring output” in FIG. 3.

In the illustrated embodiment of the invention, the first resistor R1 comprises a 1K resistor. The second resistor R2 comprises a 100 K resistor. The sense resistor RS comprises a 10K resistor. The switch SW1 is controlled to vary operation of the resistor network to sense for an open circuit condition of the crystal assembly 24 or a shorted circuit condition.

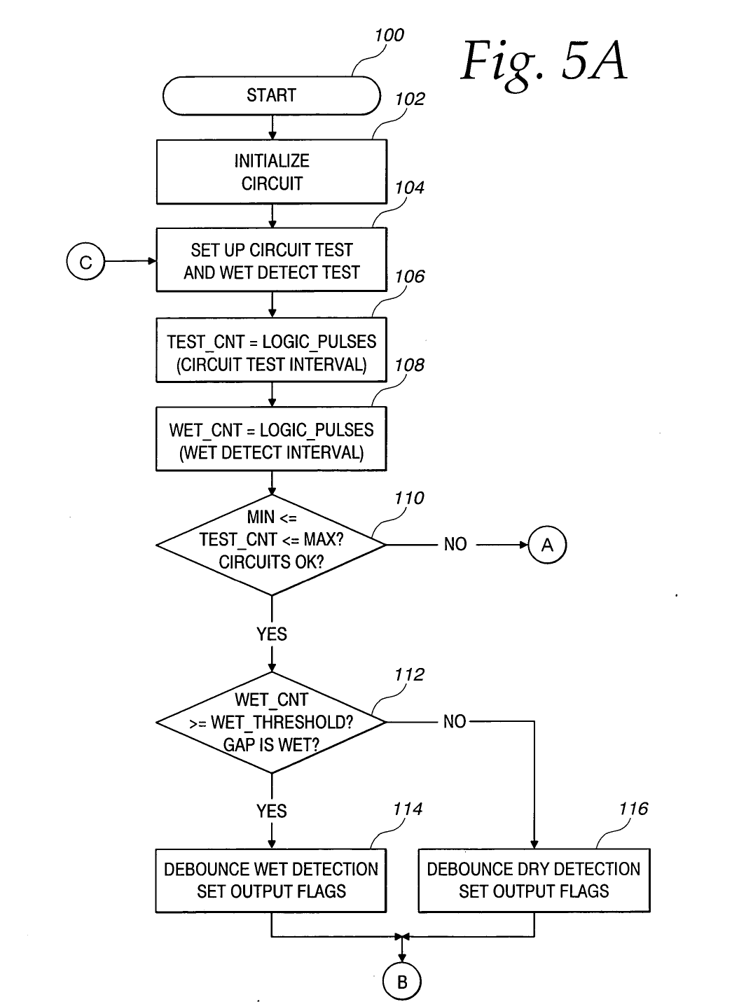

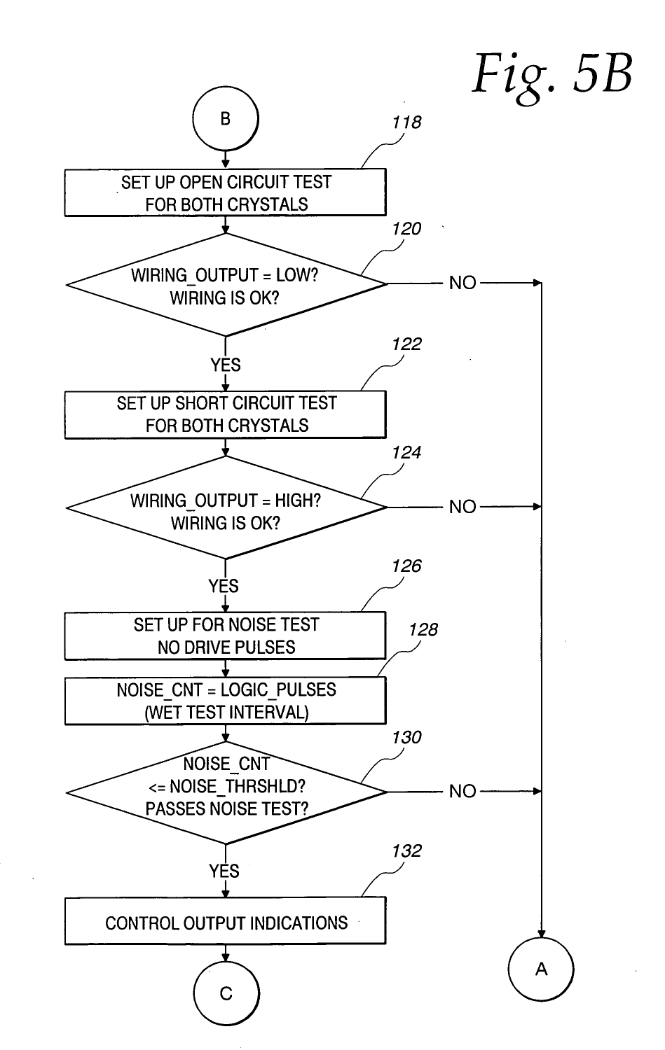

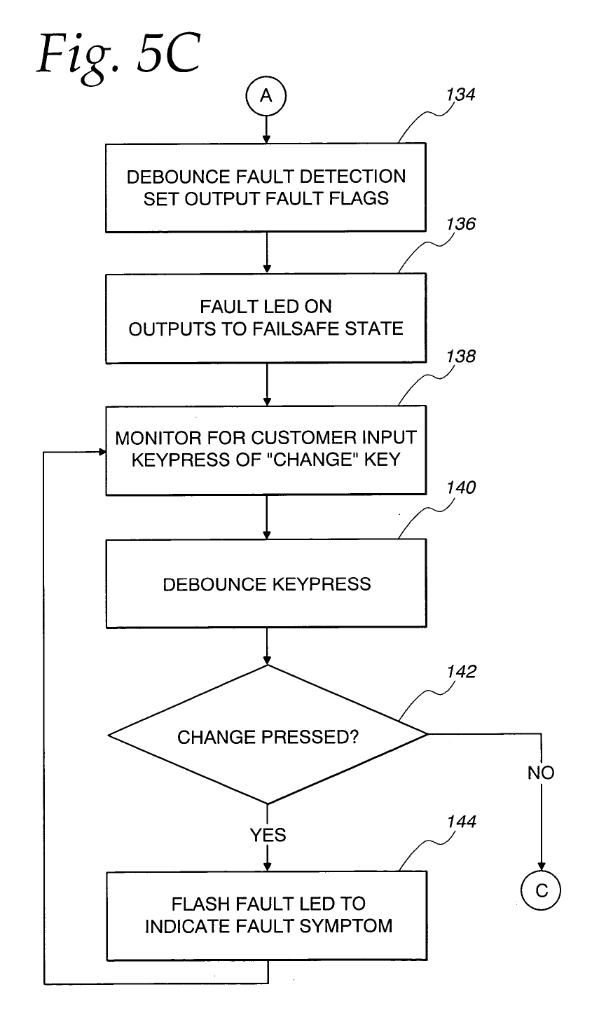

Referring to FIGS. 5A, 5B and 5C, a flow diagram illustrates a control program implemented in the controller circuit 50, see FIG. 3, for operation. The program begins at a start node 100 followed by an initialize block 102 that initializes operation of the ultrasonic circuit 60 in a conventional manner. A block 104 performs a set up for a circuit test and wet detect test by reading various values, described below, from memory in the controller circuit 50. Initially, the controller circuit 50 performs a circuit test followed by the routine wet detection. These tests are described in connection with the timing diagram of FIG. 6.

The timing diagram of FIG. 6 includes a curve 200 representing a transmit drive signal output to the transmit circuit 52. This consists of a series of pulses beginning at a time T1 and ending at a time T2. Conventionally, the receive circuit 54 begins wet detection at a time T3 subsequent to the time T2 and for a time interval ending at a time T4. With a conventional ultrasonic measurement instrument of the type described herein, the controller circuit 50 ignores logic pulses from the receive circuit 54 between the times T1 and T3. In accordance with the invention, the controller circuit 50 defines a circuit test interval as a time between the times T1 and T2. The controller circuit 50 looks for pulses in the circuit test interval representing the pulses delivered from the transmit circuit 52 to the receive circuit 54 through the circuitry test circuit 64. A curve 202 shows the receive analog signal input to the receive circuit 54 with a dry sensor condition, and a curve 204 represents the LOGIC PULSES transmitted from the receive circuit 54 to the controller circuit 50 under such conditions. A curve 206 illustrates the analog signal received by the receive circuit 54 with a wet sensor condition, and the curve 208 represents the LOGIC PULSES signal resulting therefrom and delivered to the controller circuit 50. In accordance with the invention, the circuit test comprises the controller circuit 50 verifying that the number of receive pulses during the circuit test interval generally matches the number of driven pulses represented in the curve 200.

Particularly, referring again to FIG. 5A, a block 106 determines a test count TEST_CNT value equal to the number of logic pulses received during the circuit test interval T1 to T2. A block 108 determines a value wet count value WET_CNT equal to the number of logic pulses received during the wet detection test interval between the times T3 and T4. As is apparent with reference to FIG. 6, with a dry sensor there are no pulses received in the wet detection test interval. A decision block 110 determines if the test count is greater than or equal to a MIN value and less than or equal to a MAX value. The MIN and MAX value define a range of number of pulses to be received to determine if the circuit test operation is satisfactory. If the test count is less than the MIN value or greater than the MAX value, then the self test has detected a fault condition and the control proceeds to a node A, discussed below. If the test count value is in a proper range, then a decision block 112 determines if the wet count is greater than or equal to a wet threshold. The wet threshold is a number selected to determine whether the number of pulses received is sufficient to indicate a wet condition. If so, then an output flag is set for wet detection at a block 114. If not, then the output flag is set for dry detection at a block 116.

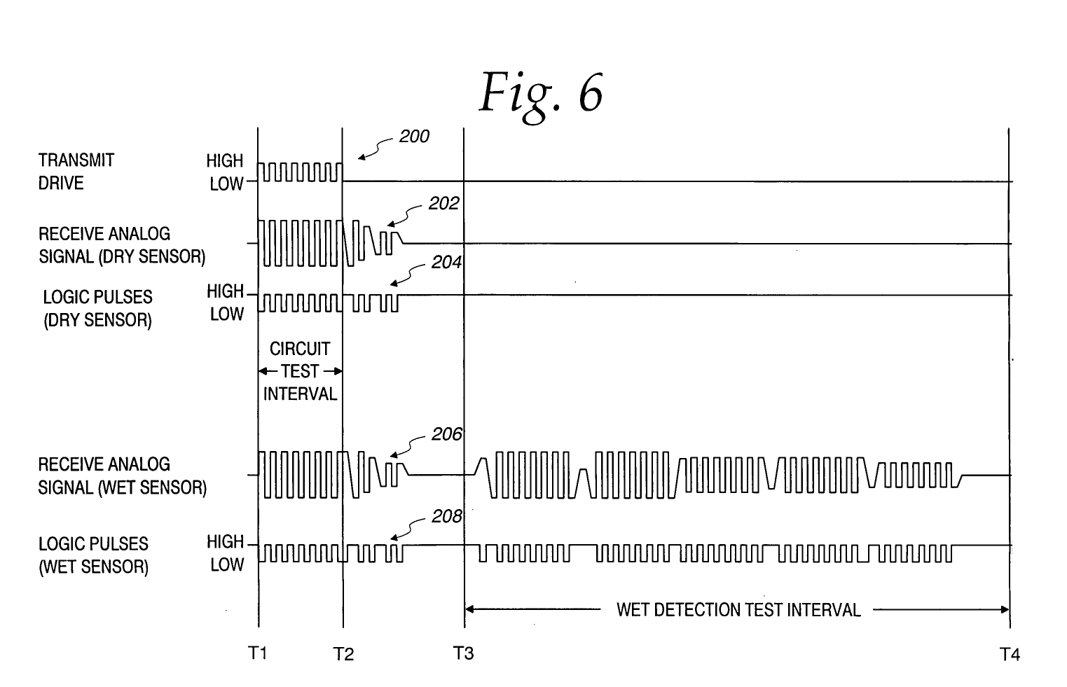

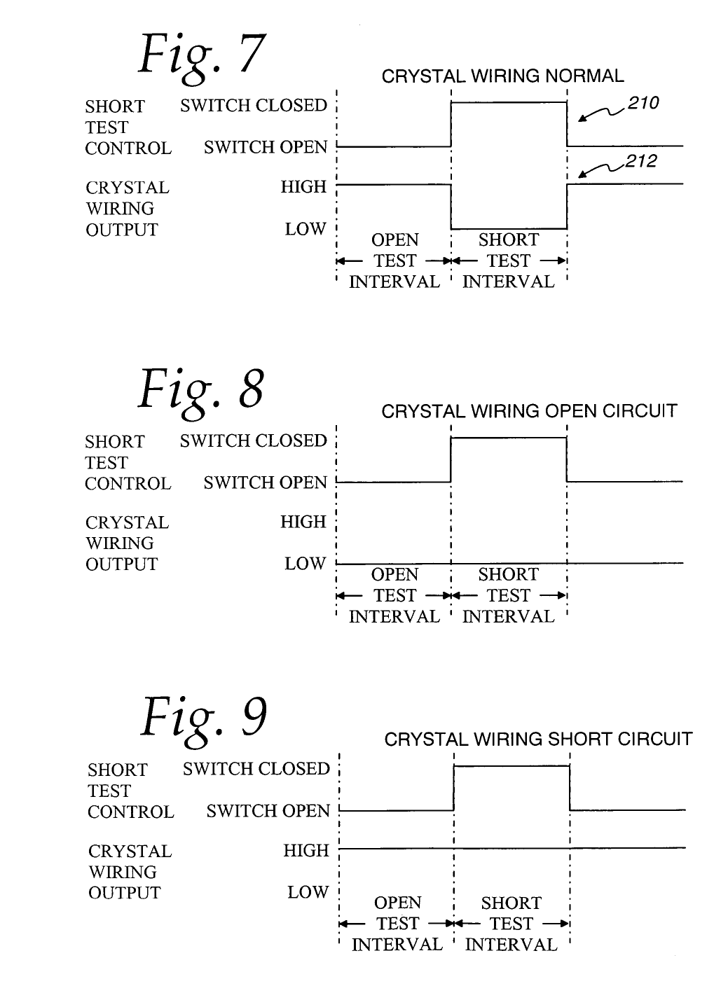

From either block 114 or 116, control advances via a node B to a block 118 on FIG. 5B that sets up an open circuit test for both crystal assemblies 24A and 24B. Both tests are similar and only one is specifically illustrated in the flow diagram. Referring to FIG. 7, a timing diagram includes a curve 210 representing the switch control signal at the node 70 of FIG. 4 to operate the switch SW1 and a curve 212 representing state of the wiring output from the inverter output at the node 74. FIG. 7 illustrates operation if crystal wiring is normal. Particularly, if the switch SW1 is open, the input voltage to the inverter 72 is low so that its output is high. This is because the resistor network is formed by the resistors R2 and RS. When the switch SW1 is closed, the effective resistance of the resistors R1 and R2 is substantially smaller than the resistance of the sense resistor RS so that the inverter input goes high and its output low, as shown. FIG. 8 illustrates the crystal wiring output with an open circuit condition. Particularly, with the switch SW1 open with an open circuit condition, the input to the inverter 72 is always high so that its output at the node 74 is always low. FIG. 9 illustrates the crystal wiring output with a short circuit condition. With a short circuit condition, the input to the inverter 72 remains low so that the inverter output at the node 74 is always high.

Referring again to the flow diagram of FIG. 5B, a decision block 120 performs the open circuit test by determining if the crystal wiring output is low during the open test interval, i.e., the switch open. If the wiring is not OK and control proceeds to the node A. If the wiring is OK, then the control sets up a short circuit test at a block 122. A decision block 124 implements the short circuit test by determining if the crystal wiring output is high during the short test interval, i.e., the switch is closed. If so, then wiring is not OK and control proceeds to the node A. If the wiring is okay, then the wiring test passes and control proceeds to a block 126 to set up for a noise test. During the noise test, no pulses are generated by the transmit circuit 52. A block 128 counts LOGIC PULSES to generate a noise count during the wet test interval. A decision block 130 verifies that the noise count is less than or equal to a select noise threshold value. If not, then a fault condition exists and the control proceeds to the node A. If so, then output indications are sent to the output circuit 56 at a block 132 and control advances to a node C as by returning to the block 104 of FIG. 5A, discussed above.

Referring to FIG. 5C, from the node A, an output fault flag is set for fault detection at a block 134. The fault LED 56a is turned on at a block 136 and the output circuit 56 is set to a fail safe state at a block 136. A block 138 monitors for a customer input key press of a change key. The key press is debounced at a block 140 and a decision block 142 determines if a change has been pressed. If not, then control proceeds to the node C. If so, then the fault LED 56a is flashed to indicate a fault symptom at a block 144 and control returns to the block 138. The timing, duration and/or number of flashes can be controlled to indicate the fault condition detected; open, short, circuit or noise

Thus, in accordance with the invention, the self test circuit 62 periodically tests operation of the ultrasonic circuit 60. The self test circuit 62 tests wiring to the crystals 38A and 38B and overall circuit operation. An advantage of the invention is that the fault indication can be used as a diagnostic tool. Because the three self-test functions are independent of each other, the instrument can report whether a fault is caused by a failed sensor or sensor wiring, a failed measurement circuit or an improper or problematic customer installation (as indicated by noise test failure).

We claim:

1. An ultrasonic measurement instrument comprising:
a housing including a pair of spaced apart legs to define a gap therebetween, each leg including an interior cavity;
an ultrasonic circuit comprising a transmit circuit for driving a transmit crystal received in the interior cavity of one of the legs and a receive circuit for receiving signals from a receive crystal in the interior cavity of the other of the legs;
a measurement circuit connected to the ultrasonic circuit to periodically generate pulses in the transmit crystal and to sense pulses from the receive crystal to detect presence of a material in the gap; and
a self test circuit operatively associated with the measurement circuit and electrically connected to the ultrasonic circuit for periodically testing operation of the ultrasonic circuit.

2. The ultrasonic measurement instrument of claim 1 wherein the self test circuit comprises a sense resistor connected across each crystal and a resistor network selectively connected to each sense resistor and the measurement circuit detects each resistor network to confirm that each crystal is properly connected.

3. The ultrasonic measurement instrument of claim 2 wherein the measurement circuit selectively varies resistance of each resistor network to test for open and shorted circuit conditions.

4. The ultrasonic measurement instrument of claim 1 wherein the self test circuit comprises a circuitry test circuit electrically connected between the transmit circuit and the receive circuit so that a portion of drive energy is coupled from the transmit circuit to the receive circuit and the measurement circuit verifies that a number of received electrical pulses generally matches a number of driven pulses to confirm operation of the ultrasonic circuit.

5. The ultrasonic measurement instrument of claim 4 wherein the self test circuit comprises a capacitor and a resistor connected in series between the transmit circuit and the receive circuit.

6. The ultrasonic measurement instrument of claim 1 wherein the measurement circuit implements a noise test to detect sense pulses from the receive crystal in the absence of any generated pulses in the transmit crystal.

7. The ultrasonic measure and circuit of claim 1 wherein the self test circuit detects faults caused by a failed crystal or crystal wiring, a failed measurement circuit and an improper installation.

8. The ultrasonic measurement circuit of claim 7 further comprising a fault indicator operatively associated with the measurement circuit for indicating the type of fault detected by the self test circuit.

9. An ultrasonic measurement instrument comprising:
a housing including a pair of spaced apart legs to define a gap therebetween, each leg including an interior cavity;
an ultrasonic circuit comprising a pair of crystal assemblies each comprising a crystal having a sense resistor connected across the crystal, each of the crystal assemblies being received in the interior cavity of one of the legs;
a measurement circuit connected to the ultrasonic circuit to periodically generate pulses in one of the crystals and to sense pulses from the other crystal to detect presence of a material in the gap; and
a self test circuit operatively associated with the measurement circuit comprising a resistor network selectively connected to each sense resistor and the measurement circuit detects each resistor network to confirm that each crystal is properly connected.

10. The ultrasonic measurement instrument of claim 9 wherein the measurement circuit selectively varies resistance of each resistor network to test for open and shorted circuit conditions.

11. The ultrasonic measurement instrument of claim 9 wherein the ultrasonic circuit further comprises a transmit circuit for driving one of the crystals and a receive circuit for receiving signals from the other crystal.

12. The ultrasonic measurement instrument of claim 11 wherein the self test circuit further comprises a circuitry test circuit electrically connected between the transmit circuit and the receive circuit so that a portion of drive energy is coupled from the transmit circuit to the receive circuit and the measurement circuit verifies that a number of received electrical pulses generally matches a number of driven pulses to confirm operation of the ultrasonic circuit.

13. The ultrasonic measurement instrument of claim 12 wherein the self test circuit comprises a capacitor and a resistor connected in series between the transmit circuit and the receive circuit.

14. The ultrasonic measurement instrument of claim 9 wherein the measurement circuit implements a noise test to detect sense pulses from the receive crystal in the absence of any generated pulses in the transmit crystal.

15. The ultrasonic measure and circuit of claim 9 wherein the self test circuit detects faults caused by a failed crystal or crystal wiring, a failed measurement circuit and an improper installation.

16. The ultrasonic measurement circuit of claim 15 further comprising a fault indicator operatively associated with the measurement circuit for indicating the type of fault detected by the self test circuit.

17. An ultrasonic measurement instrument comprising:
a housing including a pair of spaced apart legs to define a gap therebetween, each leg including an interior cavity;
an ultrasonic circuit comprising a transmit circuit for driving a transmit crystal received in the interior cavity of one of the legs and a receive circuit for receiving signals from a receive crystal in the interior cavity of the other of the legs;
a measurement circuit connected to the ultrasonic circuit to periodically generate pulses in the transmit crystal and to sense pulses from the receive crystal to detect presence of a material in the gap; and
a self test circuit operatively associated with the measurement circuit comprising a circuitry test circuit electrically connected between the transmit circuit and the receive circuit so that a portion of drive energy is coupled from the transmit circuit to the receive circuit and the measurement circuit verifies that a number of received electrical pulses generally matches a number of driven pulses to confirm operation of the ultrasonic circuit.

18. The ultrasonic measurement instrument of claim 17 wherein the self test circuit further comprises a sense resistor connected across each crystal and a resistor network selectively connected to each sense resistor and the measurement circuit detects each resistor network to confirm that each crystal is properly connected.

19. The ultrasonic measurement instrument of claim 18 wherein the measurement circuit selectively varies resistance of each resistor network to test for open and shorted circuit conditions.

20. The ultrasonic measurement instrument of claim 17 wherein the circuitry test circuit comprises a capacitor and a resistor connected in series between the transmit circuit and the receive circuit.

21. The ultrasonic measurement instrument of claim 17 wherein the measurement circuit implements a noise test to detect sense pulses from the receive crystal in the absence of any generated pulses in the transmit crystal.

22. The ultrasonic measure and circuit of claim 21 wherein the self test circuit detects faults caused by a failed crystal or crystal wiring, a failed measurement circuit and an improper installation.

23. The ultrasonic measurement circuit of claim 22 further comprising a fault indicator operatively associated with the measurement circuit for indicating the type of fault detected by the self test circuit.
